(19) United States
(12) Patent Application Publication
(10) Pub. No.: US 2010/0102246 A1
(43) Pub. Date: Apr. 29, 2010

(54) APPARATUS AND METHOD FOR MONITORING BEAM POSITION BY USING ELECTROOPTIC EFFECT

(75) Inventors: Yong Woon PARK, Pohang-si (KR); In Soo Ko, Pohang-si (KR)

Correspondence Address: OCCHIUTI ROHLICEK & TSAO, LLP, 10 FAWCETT STREET, CAMBRIDGE, MA, 02138, US

(73) Assignee: POSTECH Academy-Industry Foundation, Pohang (KR)

(21) Appl. No.: 12/483,654

(22) Filed: Jun. 12, 2009

(30) Foreign Application Priority Data
Oct. 27, 2008 (KR) 10-2008-0105533

(51) Int. Cl. H01J 3/14

(52) U.S. Cl. 250/397

(57) ABSTRACT

An apparatus and method for monitoring a beam position using an electrooptic effect are disclosed. The apparatus for measuring the position of a charged particle passing through the interior of an accelerator includes: a crystal positioned within the accelerator and allowing laser generated from a laser generating unit to pass therethrough; a polarization unit polarizing the laser that has passed through the crystal; and a measurement unit measuring the polarized state of the polarized laser to monitor the charged particle. The position of the charged particle passing through the interior of the accelerator can be more accurately measured.

### CROSS-REFERENCE TO RELATED APPLICATIONS

This application claims the benefit of priority of Korean Patent Application No. 10-2008-0105533 filed on Oct. 27, 2008 which is incorporated by reference in its entirety herein.

### BACKGROUND OF THE INVENTION

1. Field of the Invention

The present invention relates to a beam position monitor (BPM) and method and, more particularly, to an apparatus and method for monitoring a beam position by using electrooptic effect capable of measuring the position of a charged particle passing through the interior of an accelerator by using crystal that has an electrooptic effect.

2. Description of the Related Art

In general, a beam position monitor (BPM) is installed within an accelerator. The BPM measures the position of a charged particle included in beam that passes through the interior of the accelerator.

The charged particle refers to a particle assuming an electric charge, including electron, ion, proton, and the like.

Various types of equipments have been employed for beam position monitoring, a typical one of which is a radio frequency-beam position monitor (RF-BPM). However, the RF-BPM measures a dipole generated due to a change in the position of the charged particle within the accelerator, without discriminating the direction of the charged particle.

In addition, because the related art BPM measures the position of the charged particle by using electrical properties, e.g., through current measurement using a current transformer, causing a few percentage range of an error, its accuracy is limited.

### SUMMARY OF THE INVENTION

Therefore, an object of the present invention is to provide an apparatus and method for monitoring a beam position by using electrooptic effect capable of measuring the position of a charged particle passing through the interior of an accelerator by using optical properties of a crystal.

Another object of the present invention is to provide an apparatus and method for monitoring a beam position by using electrooptic effect capable of accurately measuring the position of a charged particle by adjusting the position of a crystal.

To achieve the above objects, in one aspect, there is provided a beam position monitoring apparatus for measuring the position of a charged particle passing through the interior of an accelerator using an electrooptic effect, including: a crystal positioned within the accelerator and allowing laser generated from a laser generating unit to pass therethrough; a polarization unit polarizing the laser that has passed through the crystal; and a measurement unit measuring the polarized state of the polarized laser to monitor the charged particle.

The crystal may be positioned such that its [−1,1,0] axis is perpendicular to an electric field generated by the charged particle.

The measurement unit may measure the laser by using equation shown below:

$$Γ = {\sum }_{j = 1}^{N} \frac{2 π d}{{λ}_{0} N} ( {n}_{1}^{′} ( {E}_{j} ) - {n}_{2}^{′} ( {E}_{j} ) ) ,$$

wherein λ₀ is the wavelength of the laser, ‘d’ is the thickness of the crystal, ‘N’ is the number of sections obtained by dividing the crystal, n1′ and n2′ are refractive indices of the crystal, ‘E’ is the electric field applied to the crystal, and ‘j’ is the jth section of the crystal.

The beam position monitoring apparatus may include a reflection unit configured to reflect the laser so as to be made incident to the crystal and the polarization unit.

The beam position monitoring apparatus may include a transmission window allowing the laser to transmit to the interior of the accelerator.

To achieve the above objects, in another aspect, there is provided a beam position monitoring apparatus for measuring the position of a charged particle passing through the interior of an accelerator using an electrooptic effect, including: allowing laser to pass through a crystal positioned within the accelerator; and measuring a polarized state of the laser changing due to the charged particle that passes through a position adjacent to the crystal.

The crystal may be positioned such that its [−1,1,0] axis is perpendicular to an electric field generated by the charged particle.

The measuring may be measuring of the polarized state by using equation shown below:

$$Γ = {\sum }_{j = 1}^{N} \frac{2 π d}{{λ}_{0} N} ( {n}_{1}^{′} ( {E}_{j} ) - {n}_{2}^{′} ( {E}_{j} ) ) ,$$

wherein λ₀ is the wavelength of the laser, ‘d’ is the thickness of the crystal, ‘N’ is the number of sections obtained by dividing the crystal, n1′ and n2′ are refractive indices of the crystal, ‘E’ is the electric field applied to the crystal, and ‘j’ is the jth section of the crystal.

The measuring may be measuring of a change in the brightness of the laser.

According to the present invention, the apparatus and method for monitoring beam position by using electrooptic effect have the advantages that because the position of a charged particle is measured by using the optical qualities of the crystal, the position of the charged particle passing through the interior of the accelerator can be more accurately measured.

In addition, in measuring the position of the charged particle, the crystal is positioned such that its [−1,1,0] axis is perpendicular to the electric field generated by the charged particle, so the position of the charged particle can be more accurately measured.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a perspective view of a beam position monitoring apparatus according to an exemplary embodiment of the present invention.

FIGS. 2a and 2b illustrate the axes of crystal in rectangular coordinates.

FIG. 3 illustrates the position of the crystal in the beam position monitoring apparatus according to an exemplary embodiment of the present invention.

FIGS. 4a and 4b illustrate a method of measuring the position of a charged particle by using the beam position monitoring apparatus according to an exemplary embodiment of the present invention.

FIG. 5 is a graph showing the results of measurement of the position of the charged particle over the position of the crystal.

FIG. 6 is a flow chart illustrating a beam position monitoring method according to an exemplary embodiment of the present invention.

### DETAILED DESCRIPTION OF THE PREFERRED EMBODIMENT

The present invention will now be described more fully hereinafter with reference to the accompanying drawings. In describing the present invention, if a detailed explanation for a related known function or construction is considered to unnecessarily divert the gist of the present invention, such explanation has been omitted but would be understood by those skilled in the art.

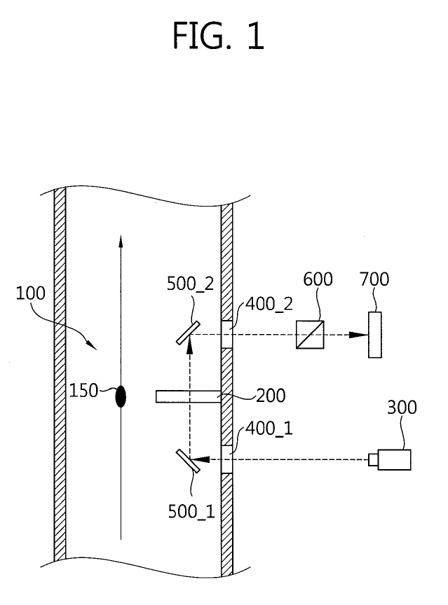

FIG. 1 is a perspective view of a beam position monitoring apparatus according to an exemplary embodiment of the present invention.

With reference to FIG. 1, the beam position monitoring apparatus according to an exemplary embodiment of the present invention includes an accelerator 100, a crystal 200, a laser generating unit 300, a plurality of transmission windows 400_1 and 400_2, a plurality of reflection units 500_1 and 500_2, a polarization unit 600, and a measurement unit 700.

The accelerator 100 accelerates a charged particle 150 that passes through the interior of the accelerator. The accelerator may have a circular or linear shape. If the accelerator has a circular shape, the position of the charged particle that changes when the charged particle 150 rotates within the accelerator is measured to perform beam position monitoring, and if the accelerator 100 has a linear shape, the position of the charged particle 150 when the charged particle 150 passes through the interior of the accelerator 100 is measured to perform beam position monitoring. Accordingly, the skilled person in the art may selectively use the circular accelerator and the linear accelerator.

The crystal 200 is positioned within the accelerator 100. As the crystal 200, an optical crystal such as ZnTe (Zinc Telluride), GaP, and the like, may be used. The crystal 200 may be positioned at one side within the accelerator 100 such that its [−1,1,0] is perpendicular to the electric field generated by the charged particle 150. The crystal 200 will be described in detail later.

The laser generating unit 300, configured to generates laser, is positioned to allow laser to pass through the crystal 200 positioned within the accelerator 100.

The transmission windows 400_1 and 400_2 may be divided into a first transmission window 400_1 allowing laser generated from the laser generating unit 300 to transmit to the interior of the accelerator 100 and a second transmission window 400_2 allowing the laser which has passed through the crystal 200 to transmit to the exterior of the accelerator 100. The first and second transmission windows 400_1 and 400_2 may be formed or installed at one side of the accelerator 100.

The reflection units 500_1 and 500_2 reflect the laser so as to be made incident to the crystal 200 and the polarization unit 600, and preferably, they are positioned at the inner side of the accelerator 100. The reflection units 500_1 and 500_2 may be divided into a first reflection unit 500_1 reflecting the laser, which has been made incident upon transmission of the first transmission window 400_1, so as to be made incident to the crystal 200 and a second reflection unit 500_2 reflecting the laser, which has been made incident upon passing through the crystal 200, so as to transmit through the second transmission window 400_2.

The polarization unit 600 is positioned outside the accelerator 100 and polarizes the laser which has transmitted the second transmission window 400_2. The polarization unit 600 may be implemented as a polarizer such as a multi-flat panel, Polaroid thin film, prism, or flat panel type polarizer, and the like.

The measurement unit 700, configured to measure a polarized state of the laser polarized by the polarization unit 600, may be implemented as a camera, a photodiode, and the like.

When the charged particle 150 passes by the crystal 200, optical qualities of the crystal 200 change due to an electric field generated by the charged particle 150. At this time, when laser passes through the crystal 200, qualities of the laser (the amount of S and P components included in the laser) also change. Namely, if the polarization unit 600 is set to polarize only the S component of the laser, the amount of S component of the laser coming through the polarization unit 600 is changed.

Accordingly, as the polarized state of the laser changes, the brightness of the laser coming through the polarization unit 600 also changes, which can be measured by using the measurement unit 700 to measure the position of the charged particle 150.

The skilled person in the art may selectively measure one of the S and P components of the laser polarized by the polarization unit 600, for the sake of convenience.

With such configuration, the laser generated from the laser generating unit 300 transmits through the first transmission window 400_1, is reflected by the first reflection unit 500_1, and then passes through the crystal 200 positioned within the accelerator 100. Thereafter, the laser, which has passed through the crystal 200, is reflected by the second reflection unit 500_2, transmits through the second transmission window 400_2, and then comes out of the accelerator 100. The laser is then polarized by the polarization unit 600, and the measurement unit 700 may measure a change in the brightness of the polarized laser to thus measure the position of the charged particle 150.

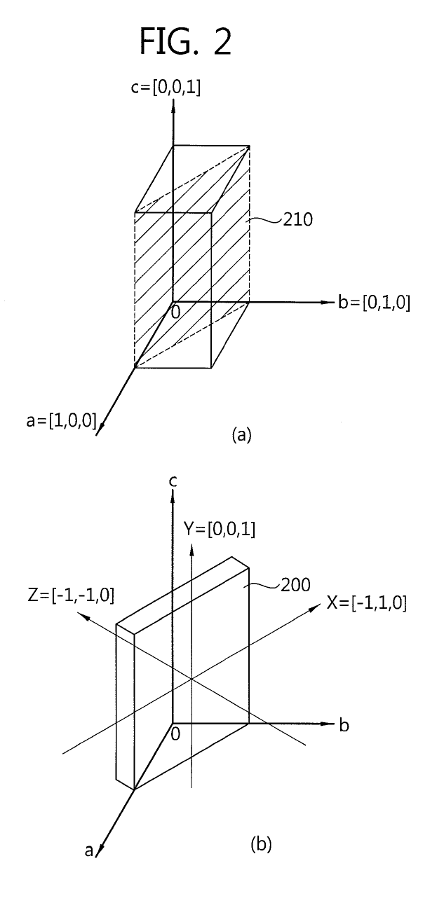

FIGS. 2a and 2b illustrate the axes of the crystal in rectangular coordinates.

First, as shown in FIG. 2a, the crystal 200 may be cut away based on a plane 210 included in a regular hexahedron (i.e., a cube) formed by coordinates a=[1,0,0], b=[0,1,0], and c=[0,0,1] from rectangular coordinates including a, b, and c axes.

In this case, the axes of the crystal 200 may be represented by X=[−1,1,0] axis, Y=[0,0,1] axis, and Z=[−1,−1,0] axis, respectively.

Laser may pass through the crystal 200 via the Z axis.

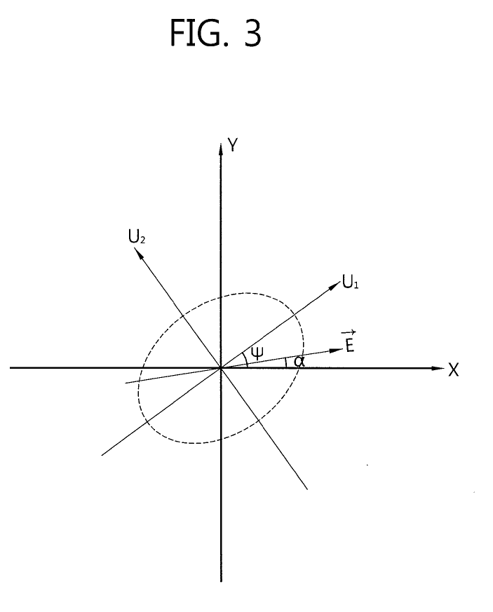

FIG. 3 illustrates the position of the crystal 200 in the beam position monitoring apparatus according to an exemplary embodiment of the present invention.

In FIG. 3, ‘α’ is the angle between the X axis of the crystal 200 and a magnetic field (\vec{E}), ‘ψ’ is the angle between the X axis of the crystal 200 and a U₁ axis, U₁ is an arbitrary axis changing over an electric field generated from the charged particle, and U₂ is an arbitrary axis making a right angle with the U₁ axis.

The direction and a refractive index may be considered to determine the position of the crystal 200. A correlation between the direction and the refractive index may be calculated from the constant energy surface in a vector space and a tensor that is linear to an electric field.

First, an index ellipse of the crystal 200 may be represented by Equation 1 shown below:

$$\frac{{U}_{1}^{2}}{{n}_{1}^{2}} + \frac{{U}_{2}^{2}}{{n}_{2}^{2}} = 1 \qquad [ Equation 1 ]$$

wherein n₁ and n₂ indicate refractive indices.

If it is assumed that laser is linearly polarized in the horizontal direction (X axis direction) in FIG. 3, the refractive indices with respect to the U₁ and U₂ axes may be calculated from the index ellipse equation of Equation 1.

The refractive indices with respect to the U₁ and U₂ axes may be represented by Equation 2 shown below:

$${n}_{1} = {n}_{0} + \frac{{n}_{0}^{3} {r}_{41} E}{2} ( sin α + \sqrt{1 + 3 {cos}^{2} α} ) , \\ {n}_{2} = {n}_{0} + \frac{{n}_{0}^{2} {r}_{41} E}{2} ( sin α - \sqrt{1 + 3 {cos}^{2} α} ) . \qquad [ Equation 2 ]$$

wherein n₀ is an initial refractive index and r₄₁ is an electrooptic constant.

Meanwhile, the relationship between the angle (α) between the X axis of the crystal 200 and the electric field (\vec{E}) and the angle (ψ) between the X axis of the crystal 200 and the U₁ axis may be represented by Equation 3 shown below:

$$cos 2 ψ = \frac{sin α}{\sqrt{1 + 3 {cos}^{2} α}} . \qquad [ Equation 3 ]$$

When the electric field is parallel to the X axis, the U1 and U2 axes make an angle of 45 degrees with the X and Y axes of the crystal 200, respectively.

The difference between the refractive index of the horizontal component and that of the vertical component of laser varies polarization of the laser. This is called a relative phase shift, and a phase shift equation (Γ) may be represented by Equation 4 shown below:

$$Γ = \frac{{ω}_{0} d}{c} ( {n}_{1} - {n}_{2} ) = \frac{2 π d}{{λ}_{0}} {n}_{0}^{3} {r}_{41} E \sqrt{1 + 3 {cos}^{2} α} \qquad [ Equation 4 ]$$

wherein ‘d’ is the thickness of the crystal 200, ω₀ is the average angular frequency of the laser phase, ‘c’ is the speed of light in a free space, λ₀ is the average wavelength of the laser, and ‘E’ is the electric field working on the crystal 200.

As shown in Equation 4, it is noted that the maximum electrooptic effect is obtained when the angle (α) between the X axis of the crystal 200 and the electric field (\vec{E}) is 0 degree. In addition, it is noted that a minimum electrooptic effect is obtained when the angle (α) between the X axis of the crystal 200 and the electric field (\vec{E}) is 90 degrees. In order to measure the position of the charged particle, preferably, the crystal 200 is positioned such that the angle (α) between the X axis of the crystal 200 and the electric field (\vec{E}) is perpendicular (i.e., 90 degrees) within the accelerator 100.

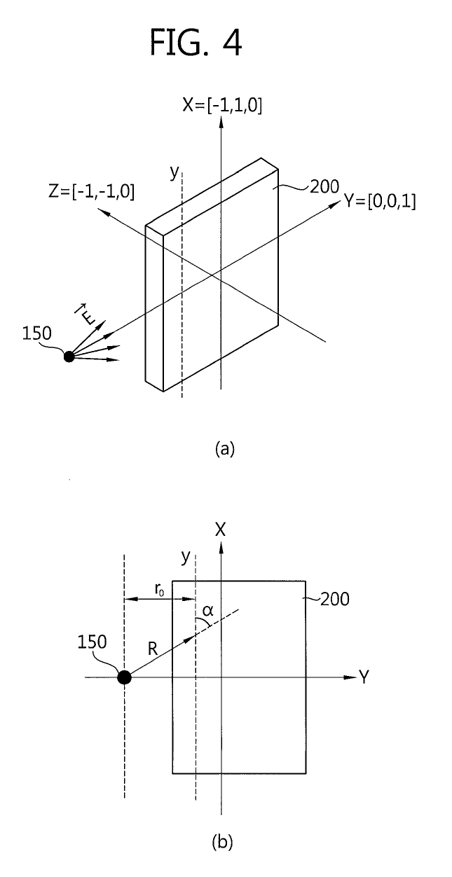

FIGS. 4a and 4b illustrate a method of measuring the position of the charged particle by using the beam position monitoring apparatus according to an exemplary embodiment of the present invention.

As shown in FIG. 4a, the crystal 200 is positioned to allow laser to pass therethrough in the Z axis direction, and in this case, the laser may pass through one point on a virtual axis (y).

In FIG. 4b, ‘R’ indicates the distance between the center of the charged particle and the point at which the laser passes through, and r₀ indicates the distance between the charged particle and the virtual axis (y).

As shown in FIGS. 4a and 4b, the position of the charged particle changes within the accelerator 100. Preferably, the X axis of the crystal 200 is positioned to be perpendicular to the horizontal plane.

In order to obtain the refractive index of the crystal 200, the refractive indices with respect to the U₁ and U₂ axes as represented by Equation 2 must be changed to refractive indices with respect to the X and Y axes by using Equation 5 shown below:

$$( \begin{matrix}{U}_{1} \\ {U}_{2}\end{matrix} ) = ( \begin{matrix}cos Ψ & sin Ψ \\ - sin Ψ & cos Ψ\end{matrix} ) ( \begin{matrix}X \\ Y\end{matrix} ) \qquad [ Equation 5 ]$$

Equation 5 may be applied to the Equation 1 to obtain Equation 6 shown below:

$$\frac{1}{{n}_{1}^{2}} ( {X}^{2} {cos}^{2} ψ + XY sin ( 2 ψ ) + {Y}^{2} {sin}^{2} ψ ) + \frac{1}{{n}_{2}^{2}} ( {X}^{2} {cos}^{2} ψ - XY sin ( 2 ψ ) + {Y}^{2} {sin}^{2} ψ ) = 1 \qquad [ Equation 6 ]$$

Equation 6 may be used to represent refractive indices (n₁′, n₂′) with respect to new axes making 45 degrees with the X and Y axes by Equation 7 shown below:

$${n}_{2}^{′} = \sqrt{\frac{2}{\frac{1 + sin ( 2 Ψ )}{{n}_{1}^{2}} + \frac{1 - sin ( 2 Ψ )}{{n}_{2}^{2}}}} \\ {n}_{2}^{′} = \sqrt{\frac{2}{\frac{1 - sin ( 2 Ψ )}{{n}_{1}^{2}} + \frac{1 + sin ( 2 Ψ )}{{n}_{2}^{2}}}} . \qquad [ Equation 7 ]$$

As shown in Equation 7, when the angle (α) between the X axis of the crystal 200 and a magnetic field (\vec{E}) is 0 degree, the angle (ψ) between the X axis of the crystal and the U₁ axis corresponds to 45 degrees, ascertaining that the refractive indices (n₁, n₂) with respect to the U₁ and U₂ axes and the refractive indices (n₁′, n₂′) with respect to the X and Y axes are the same. Thus, the phase shift equation can be represented by Equation 8 shown below:

$$Γ = \frac{{ω}_{0} d}{c} ( {n}_{1}^{′} - {n}_{2}^{′} ) . \qquad [ Equation 8 ]$$

However, in order to apply Equation 8 to the beam position monitoring apparatus, the two following matters must be considered.

First, the crystal 200 has reflexibility (T) as represented by Equation 9 shown below:

$$T = \frac{2}{1 + n ( f ) + iκ ( f )} . \qquad [ Equation 9 ]$$

A Fourier component with respect to the electric field within the crystal 200 can be obtained by using the reflexibility (T) and fast Fourier transform (FFT), as represented by Equation 10 shown below:

Fₜᵣₐₙₛ(f)=A₀+iB₀T×FFT(E₀), [Equation 10]

wherein E₀ is the electric field before it spreads to the crystal 200, A₀ and B₀ indicate a real number part and an imaginary number part when the reflexibility (T) is multiplied to Equation 10.

The Fourier component may be represented by vector, in which the amplitude (M0) and phase (Φ) of the Fourier component are defined by Equation 11 shown below:

M₀=\sqrt{A₀²+B₀²}, [Equation 11]

Φ₀=tan⁻¹(B₀/A₀)

Each Fourier component spreads at different speeds within the crystal. The amplitude and phase of a Fourier component which has spread by the distance ‘x’ may be represented by Equation 12 shown below:

$$Φ = {Φ}_{0} - \frac{2 π {f}_{t} nx}{c} , \\ M = {M}_{0} exp ( - \frac{2 π {f}_{t} κ x}{c} ) , \qquad [ Equation 12 ]$$

wherein f₁ is the frequency of each Fourier component in the crystal 200.

Due to the change in the amplitude and phase of each Fourier component, the real number part and the imaginary number part of Equation 10 may be represented by Equation 13 shown below:

A=M cos(Φ), B=M sin(Φ). [Equation 13]

Meanwhile, an electric field can be obtained by calculating the phase and amplitude of the Fourier component at the position ‘x’, and in this case, the electric field may be calculated through inverse FFT (IFFT).

This can be represented by Equation 14 shown below:

E=IFFT[A+iB]. [Equation 14]

Second, the electric field is not a constant because of the difference of diffusion speeds of the electric fields. The crystal 200 may be divided into the N number of sections (N is a natural number of 1 or larger) to obtain its phase shift. Meanwhile, the refractive indices are affected by the electric field as shown in FIG. 2. Thus, in order to obtain the phase shift, an electric field of each section of the crystal 200 must be calculated.

The phase shift may be obtained by adding phase shifts at the respective sections of the crystal 200. It can be represented by Equation 15 shown below:

$$Γ = {\sum }_{j = 1}^{N} \frac{2 π d}{{λ}_{0} N} ( {n}_{1}^{′} ( {E}_{j} ) - {n}_{2}^{′} ( {E}_{j} ) ) , \qquad [ Equation 15 ]$$

wherein λ₀ is the wavelength of the laser, ‘d’ is the thickness of the crystal, ‘N’ is the number of sections of the crystal, n₁′ and n₂′ are refractive indices of the crystal, ‘E’ is the electric field applied to the crystal, and ‘j’ is the jth section of the crystal.

The position of the charged particle may be measured by using the phase shift obtained thusly.

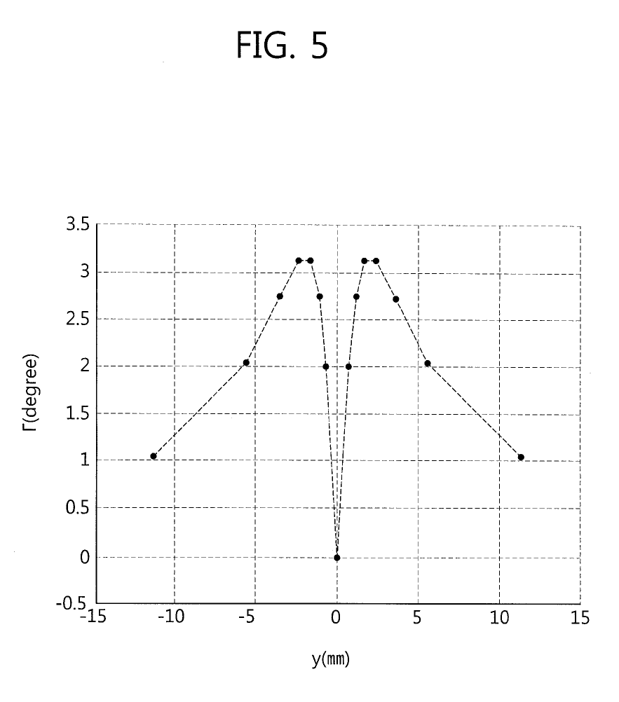

The results obtained by measuring the position of the charged particle according to the position of the crystal will now be described with reference to FIG. 5. FIG. 5 shows the phase shift value according to the distance between the charged particle and the Y axis distance (y) of the crystal 200.

As illustrated, when the charged particle exists at the position on the Y axis line of the crystal 200 within the accelerator 100 (y=0), the electrooptic effect of the crystal 200 disappears due to the refractive indices as shown in Equations 1 to 5, making the phase shift value 0. If the charged particle is positioned at an upper or lower portion, the position at which the phase shift value is 0 changes accordingly.

Accordingly, the beam position monitoring apparatus according to the present invention draws the curved line in the graph as shown in FIG. 5, which position distanced from the Y axis line the charged particle has passed through can be detected, thus accurately measuring the position of the charged particle.

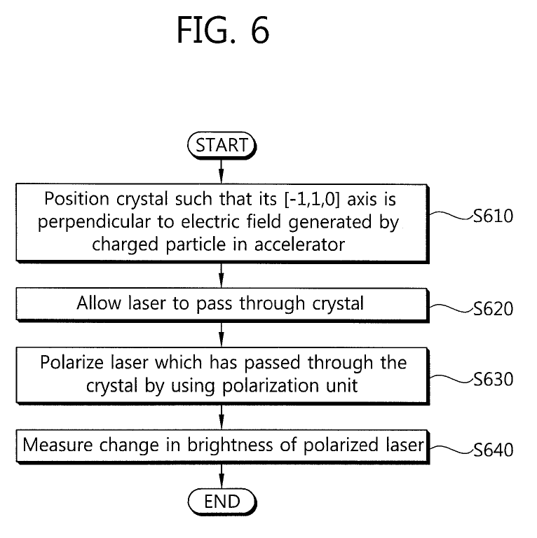

A beam position monitoring method according to an exemplary embodiment of the present invention will now be described in detail with reference to FIG. 6.

First, the crystal 200 is positioned such that its [−1,1,0] axis of the crystal 200 is perpendicular to an electric field generated by the charged particle passing through the interior of the accelerator 100 (S610).

The first transmission window 400_1 and the first reflection unit 500_1 are positioned to allow laser generated from the laser generating unit 300 to pass through the crystal 200, and also, the second transmission window 400_1 and the second reflection unit 500_2 are positioned to allow laser, which has passed through the crystal 200, to be discharged to the outer side of the accelerator 100. And then, laser is allowed to pass through the crystal 200 (S620).

Thereafter, the laser discharge after transmitting through the second transmission window 400_2 is polarized by using the polarization unit 700 (S630).

Subsequently, the polarized laser is measured by using the measurement unit 800 such as a photodiode and the like (S640).

When the charged particle 150 passes through the interior of the accelerator 100, qualities of the crystal 200 change due to the electric field generated from the charged particle. Accordingly, when the laser passes through the crystal 200, its qualities change. The laser with changed qualities are polarized by using the polarization unit 600, because the qualities of the laser, namely, at least one of the S and/or P components has changed, the brightness of the laser is changed. In this manner, the position of the charged particle can be measured by measuring the change in the brightness of the laser.

For example, if laser is generated in a linear form from the laser generating unit 300 and passes through the entire y of the crystal 200 and the charged particle 150 passes through the point corresponding to the position of the crystal 200, qualities of the crystal 200 change due to the electric field of the charged particle 150. Thus, the polarized state of the laser which has been polarized by the polarization unit 600 is changed.

At this time, when the polarized laser is measured, a region corresponding to the position of the charged particle is dark in brightness while the peripheries of the charged particle appear to be bright rapidly. Thus, in the exemplary embodiment of the present invention, the brightness at the position of the charged particle is contrasted distinctly, and thus, the position of the charged particle can be accurately measured.

All the functions described above may be performed by processors such as a microprocessor, a controller, a microcontroller, an application specific integrated circuit (ASIC), and the like, according to software coded to perform the functions, program codes, and the like. Designing, development, and implementation of such codes may be obvious to the skilled person in the art based on the description of the present invention.

The preferred embodiments of the present invention have been described with reference to the accompanying drawings, and it will be apparent to those skilled in the art that various modifications and variations can be made in the present invention without departing from the scope of the invention. Thus, it is intended that any future modifications of the embodiments of the present invention will come within the scope of the appended claims and their equivalents.

What is claimed is:

1. A beam position monitoring apparatus for measuring the position of a charged particle passing through the interior of an accelerator, the apparatus comprising:
a crystal positioned within the accelerator and allowing laser generated from a laser generating unit to pass therethrough;
a polarization unit polarizing the laser that has passed through the crystal; and
a measurement unit measuring the polarized state of the polarized laser to monitor the charged particle.

2. The apparatus of claim 1, wherein the crystal is positioned such that its [−1,1,0] axis is perpendicular to an electric field generated by the charged particle.

3. The apparatus of claim 2, wherein the measurement unit measures the laser by using equation shown below:
$$Γ = {\sum }_{j = 1}^{N} \frac{2 π d}{{λ}_{0} N} ( {n}_{1}^{′} ( {E}_{j} ) - {n}_{2}^{′} ( {E}_{j} ) ) ,$$
wherein λ₀ is the wavelength of the laser, ‘d’ is the thickness of the crystal, ‘N’ is the number of sections obtained by dividing the crystal, n1′ and n2′ are refractive indices of the crystal, ‘E’ is the electric field applied to the crystal, and ‘j’ is the jth section of the crystal.

4. The apparatus of claim 3, further comprising:
a reflection unit configured to reflect the laser so as to be made incident to the crystal and the polarization unit.

5. The apparatus of claim 3, further comprising:
a transmission window allowing the laser to transmit to the interior of the accelerator.

6. A beam position monitoring apparatus for measuring the position of a charged particle passing through the interior of an accelerator, the method comprising:
allowing laser to pass through a crystal positioned within the accelerator; and
measuring a polarized state of the laser changing due to the charged particle that passes through a position adjacent to the crystal.

7. The method of claim 6, wherein the crystal is positioned such that its [−1,1,0] axis is perpendicular to an electric field generated by the charged particle.

8. The method of claim 7, wherein the measuring is measuring of the polarized state by using equation shown below:
$$Γ = {\sum }_{j = 1}^{N} \frac{2 π d}{{λ}_{0} N} ( {n}_{1}^{′} ( {E}_{j} ) - {n}_{2}^{′} ( {E}_{j} ) ) ,$$
wherein λ₀ is the wavelength of the laser, ‘d’ is the thickness of the crystal, ‘N’ is the number of sections obtained by dividing the crystal, n1′ and n2′ are refractive indices of the crystal, ‘E’ is the electric field applied to the crystal, and ‘j’ is the jth section of the crystal.

9. The method of claim 8, wherein the measuring is measuring of a change in the brightness of the laser.
